(19) United States
(12) Patent Application Publication
(10) Pub. No.: US 2004/0083845 A1
(43) Pub. Date: May 6, 2004

(54) Adjusting mechanism of a manual transmission cable

(76) Inventor: Yang-Rae Cho, Gyeonggi-do (KR)

Correspondence Address: MORGAN, LEWIS & BOCKIUS, LLP., 3300 HILLVIEW AVENUE, PALO ALTO, CA, 94304, US

(21) Appl. No.: 10/621,913

(22) Filed: Jul. 17, 2003

(30) Foreign Application Priority Data
Oct. 31, 2002 (KR) 2002-67089

(51) Int. Cl. F16C 1/22

(52) U.S. Cl. 74/502.6

(57) ABSTRACT

An adjusting mechanism of a manual transmission cable wherein a guide connected to a cable is coupled to a slide clip for lengthwise movement of the cable, and a lever pin integrally moving with a shift lever is made to go through the guide and the slide clip at the same time, such that the slide clip slides in the longitudinal direction of the cable along the guide to enable to adjust the total length of the cable between the shift lever and the manual transmission, whereby the guide and slide clip are coupled when the slide clip is compressed to the guide, thereby enabling to maintain the adjusted length of the cable.

### FIELD OF THE INVENTION

The present invention relates to automobile transmissions and, more particularly, an adjusting mechanism for a manual transmission cable in which the cable length can be easily adjusted.

### BACKGROUND OF THE INVENTION

In general, a manual transmission, which functions in response to the shift of a shift lever, is connected to a shift lever mounted inside a vehicle via a cable. The cable runs a full length from the shift lever to the manual transmission where the cable is adjusted in length by an adjusting mechanism. A proper adjustment of the cable enables the shift lever to be correctly placed at a neutral position and the manipulating force of the shift lever to be smoothly transmitted to the manual transmission.

The conventional adjusting mechanism of a manual transmission cable includes a cable which consists of a first cable and a second cable. One end of the first cable is formed with an eye end into which a lever pin of a shift lever is inserted and the other end of the first cable is formed with a screw. With regard to the second cable, one end is connected to a manual transmission and the other end is formed with a screw. Both ends of a turn buckle are connected to the screws of the first cable and the second cable, and a pair of lock nuts are screwed to the first and the second cables respectively at both sides of the turn buckle to restrict the rotation of the turn buckle.

In the adjusting mechanism thus described, the total length of the cable is adjusted in such a way that both ends of the turn buckle are respectively connected to the screws of first and second cables when the cable is adjusted. The turn buckle is turned in either direction while the lock nuts are unscrewed from the turn buckle to allow the first and the second cables to be connected to each other or disconnected from each other. Furthermore, when the pair of lock nuts are tightened at both sides of the turn buckle after the cable is adjusted in length thereof, the turn buckle is restricted in rotation thereof and the length of the adjusted cable is maintained. Accordingly, when the cable is connected to the shift lever, the length of the cable can be optimally adjusted by turning the turn buckle in relation to the assembly environment or type of vehicle to prevent the shift lever from being biased to any given direction in a neutral range. Even in a case where the cable is varied in length, its length can be readjusted by turning the turn buckle.

### SUMMARY OF THE INVENTION

The present invention provides an adjusting mechanism for a manual transmission cable adapted to provide an improved adjusting workability and to reduce the weight and number of required components. In accordance with an embodiment of the present invention, an adjusting mechanism of manual transmission cable comprises a lever pin that integrally moves with a shift lever. A guide is connected in order to integrally move with a cable for transmitting the manipulating force of the shift lever, and centrally formed with a guide hole through which the lever pin passes to move in the longitudinal direction of the cable. The guide hole is formed in the longitudinal direction of the cable with a plurality of teeth. Both sides of the guide are formed with respective guide channels. A slide clip comprises a boss, locking protrusions and a guide part. The boss through which the lever pin passes is formed at a surface opposite to the guide hole. The locking protrusions are formed at a circumference of the boss for insertion into the teeth in the penetration direction of the lever pin. The guide part is formed on a surface opposite to the guide channels and movably coupled to the guide channels while the locking protrusions and teeth are distanced from each other and hitched at a tip end of the guide by resilience when the locking protrusions are inserted into the teeth. Fixing means is coupled to a tip end of the lever pin which passes through the boss of the slide clip to restrict the slide clip and the lever pin in case the slide clip and the lever pin should be broken away from each other.

In an alternative embodiment of the present invention, an adjusting mechanism for a manual transmission cable includes a guide member and cooperating slide clip. The guide member is adapted to be secured to an end of the transmission cable and extends in a generally longitudinal direction with respect to the cable. The guide member also defines a central opening and guide channels along top and bottom surfaces lying parallel to the longitudinal direction of the cable. The slide clip is adapted to be pivotally secured to a shift level adjacent a bottom end of the lever. The slide clip comprises a central boss and wing portions. The central boss is configured and dimensioned to be received in the central opening of the guide member and the wing portions are configured and dimensioned to extend around the top and bottom surfaces of the guide member. Preferably, guide protrusions are disposed on an inner surface of each wing portion. The guide protrusions are positioned to engage behind an edge of the guide member when in a locked position and received in the guide channels when in an adjustable position. Locking elements are disposed between the guide member and the slide clip boss such that the slide clip is fixed with respect to the guide member in the locked position and slideable with respect to the guide member in the adjustable position.

Preferably, the locking elements may comprise gear tooth-like surfaces formed on inner longitudinal surfaces of the guide member central opening and mating gear tooth-like surface formed on mating surfaces of the slide clip boss. Also, the slide clip boss defines a central hole adapted to receive a pin mounted on the shift lever.

### BRIEF DESCRIPTION OF THE DRAWINGS

For fuller understanding of the nature and objects of the invention, reference should be made to the following detailed description taken in conjunction with the accompanying drawings in which:

FIG. 1 is a perspective view of an adjusting mechanism of manual transmission cable according to one embodiment of the present invention;

FIG. 2 is an exploded perspective view of an adjusting mechanism according to an embodiment of the present invention;

FIG. 3 is a sectional view taken along a line III-III of FIG. 1; and

FIG. 4 is a sectional view taken along a line III-III of FIG. 1 when a cable is adjusted in length.

### DETAILED DESCRIPTION OF THE INVENTION

Hereinafter, the embodiment of the present invention will be described in detail with reference to the accompanying drawings.

An adjusting mechanism of a manual transmission cable according to an embodiment of the present invention comprises a lever pin 52 disposed underneath a shift lever 50 for integrally moving with the shift lever 50. The lever pin preferably may be integrally formed with the shift lever or an extension thereof. A guide 60 is connected to move with a cable 54 for transmitting the manipulating force of the shift lever 50 to the transmission and coupled so that the lever pin 52 can move with the longitudinal movement of the cable 54. A slide clip 70 is coupled to the guide 60 for longitudinal movement of the cable 54 and so coupled for movement with the lever pin 52. The slide clip 70 slides in the longitudinal direction of the cable 54 along the guide 60 when the cable 54 is adjusted in length thereof and closely attached to the guide 60. Fixing means is coupled to an end of the lever pin 52 after the slide clip 70 is closely attached to the guide 60 to restrict the slide clip 70 and the lever pin 52 from being broken away from each other.

The guide 60 is preferably rectangular-shaped in the longitudinal direction of the cable 54 and is hollow and centrally formed with a guide hole 62, being empty in the axial direction of the lever pin 52 and having a long rectangular shape in the longitudinal direction of the cable 54, to allow the lever pin 52 to penetrate and move in the longitudinal direction of the cable 54. The guide 60 is also formed at both upper and lower sides thereof with groove-shaped guide channels 66 parallel to the direction of the cable 54.

The guide hole 62 is formed therein with a plurality of teeth 64, wherein the teeth 64 are detachably formed in the longitudinal direction of the cable 54 relative to locking protrusions 73 of a slide clip 70 (described below) while a guide part 76 at the slide clip 70 is inserted into the guide channels 66.

The guide 60 is vertically and protrusively formed toward the cable 54 with a boss 68 formed with an insertion groove (not shown) in the longitudinal direction of the cable 54 to allow the cable 54 to be inserted to the longitudinal direction thereof.

The guide hole 62 is formed to have sufficient space therein in the longitudinal direction of the cable 54 to cope with maximum or minimum length of the cable 54 in relation to environmental, temperature and other conditions. The guide 60 is preferably made of a relatively light plastic material.

The slide clip 70 includes a base 71 installed in parallel with a lateral surface of the guide 60, a boss 72 vertically and centrally protruding from the base 71 for insertion into the guide hole 62 and centrally formed with a through hole 72a through which the lever pin 52 can be axially inserted. Locking protrusions 73 protrude from a periphery of the boss 72 for insertion into the teeth 64 toward the penetration direction of the lever pin 52. Upper/lower bent parts or wings 74, respectively, are perpendicularly bent toward the guide 60 from the upper/lower ends of the base 71 so as to be closely abutted onto upper/lower surfaces of the guide 60. Guide parts 76, each protruding from the inner lateral surface of the upper and lower bent part 74 slideably couple with the guide channels 66 in the longitudinal direction of the cable 54 while the locking protrusions 73 and the teeth 64 mesh at a preset distance in the axial direction of the lever pin 52. Guide parts 76 are elastically hitched at an end of the guide 60 when the slide clip 70 is closely abutted to the guide 60 to allow the locking protrusions 73 to be inserted into the teeth 64.

The boss 72 is formed in a rectangular shape and is smaller widthwise than distance between the teeth 64 of the guide 60 to be easily inserted into or removed from the guide hole 62 in the axial direction of the lever pin 52. Furthermore, the upper and lower lateral surfaces facing the teeth 64 of the guide 60 are formed in the longitudinal direction of the cable 54 with a plurality of locking protrusions 73. Each of the locking protrusions 73 is serrated as the teeth 64 of the guide 60 are, and has the same size as that of the guide 60.

Guide parts 76 are protrusively formed at a portion corresponding to the axial length of the lever pin 52 of the guide 60. Each of the guide parts 76 tapers off at an external end thereof for easy escape from the guide channels 66. The upper and lower bent parts 74 are widened outwardly to allow the guide parts 76 to escape from the guide channels 66 when the slide clip 70 is coupled to the guide 60. Each of the guide parts 76 is preferably made of resilient plastic material to be hitched at an end of the guide 60.

The fixing means is formed with a pin hole 52a radially pierced at an end portion of the lever pin 52 penetrating the boss 72 of the slide clip 70. One leg 80a of two bent legs 80a, 80b at a lock pin 80 is radially inserted into the pin hole 52a while the lock pin 80 is closely abutted on a base 71 of the slide clip 70. The other leg 80b of the lock pin 80 resiliently embraces the end portion of the lever pin 52 and bends toward the remaining leg 80a.

Hereinafter, a cable length adjusting operation according to the embodiment of the present invention thus constructed will be described below.

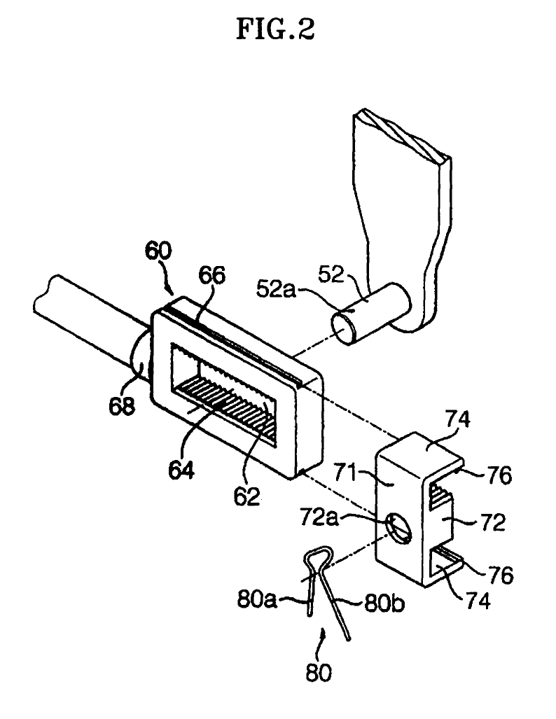

As illustrated in FIGS. 2 and 4, the guide parts 76 of the slide clip 70 are inserted into the guide channels 66 of the guide 60 connected to the cable 54 in the longitudinal direction of the cable 54 to allow the guide 60 and the slide clip 70 to be coupled. The lever pin 52 is inserted into the boss 72 of the slide clip 70 and the guide hole 62 at the guide 60 in the axial direction to prompt the lever pin 52 and the slide clip 70 to move in the longitudinal direction of the cable 54 for adjustment of the cable 54.

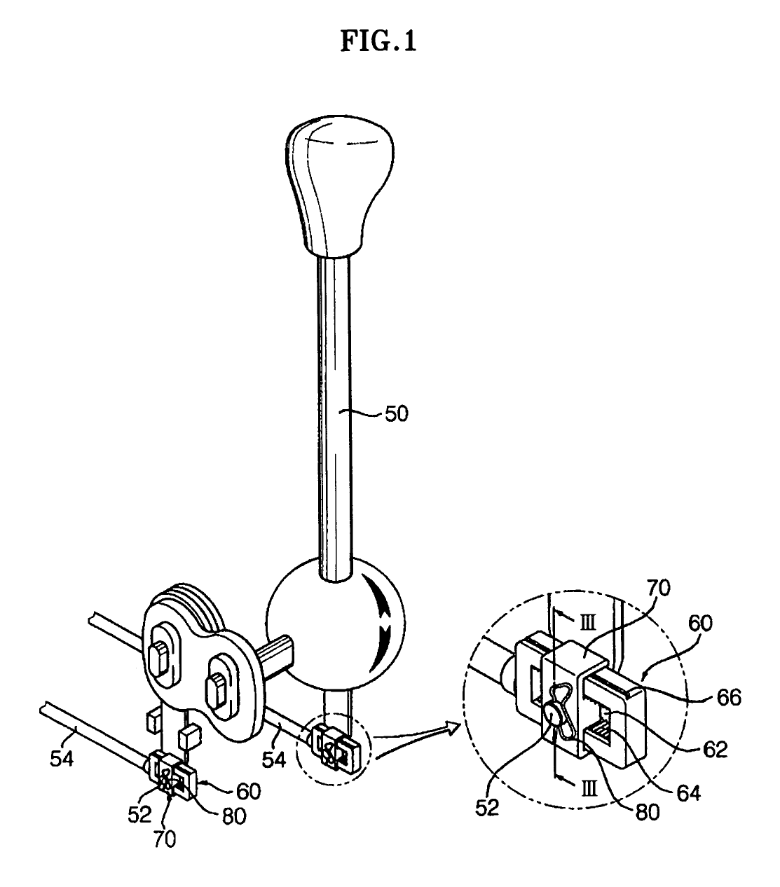

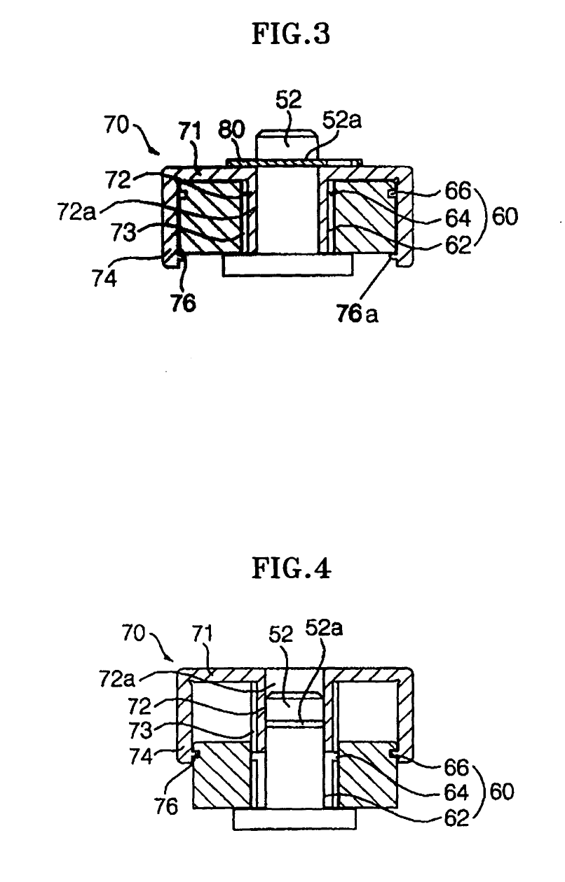

As a result, the slide clip 70 is closely abutted on the guide 60 to cause the locking protrusions 73 at the slide clip 70 to be inserted into the teeth 64 of the guide 60 as shown in FIGS. 1 and 3, such that the slide clip 70 is prevented from further moving to the longitudinal direction of the cable 54 and the guide parts 76 at the slide clip 70 are hitched at the tip end of the guide 60, thereby preventing the slide clip 70 from escaping from the guide 60. Subsequently, the slide clip 70 and guide 60 are coupled while being restricted in mutual movement thereof by the one-touch operation of coupling the slide clip 70 to the guide 60.

Furthermore, when the slide clip 70 is closely abutted to the guide 60, the lever pin 52 goes through the boss 72 of the slide clip 70, whereby the lever pin 52 comes to protrude to the external side of the slide clip at a tip end thereof. When one of the legs 80a at the lock pin 80 is inserted into and made to go through the pin hole 52a of the lever pin 52 and a tip end of the other leg 80b of the lock pin 80 resiliently embracing the periphery of the lever pin 52 is made to bend toward the remaining leg 80a of the lock pin 80 that has passed the pin hole 52a, the slide clip 70 and the guide 60 are hitched by the lock pin 80, thereby enabling to prevent the disengagement of coupling between the lever pin 52 and the slide clip 70.

Meanwhile, when it is required to re-adjust the length of the cable 54, the lock pin 80 is firstly detached from the lever pin 52 to allow the slide clip 70 to escape from the axial direction of the lever pin 52. The slide clip 70 is then removed in the opposite direction of compressing the guide 60, whereby the cable 54 is adjusted in length thereof by moving the slide clip 70 relative to the guide 60 while the guide part 76 is inserted into the guide channels 66.

As apparent from the foregoing, there is an advantage in the adjusting mechanism of a manual transmission cable thus described in that a guide connected to a cable is coupled to a slide clip for lengthwise movement of the cable, and a lever pin integrally moving with a shift lever is made to go through the guide and the slide clip at the same time, such that the slide clip slides in the longitudinal direction of the cable along the guide to enable to adjust the total length of the cable between the shift lever and the manual transmission, whereby the guide and the slide clip are coupled when the slide clip is closely abutted to the guide, thereby enabling to adjust the length of the cable by one-touch operation and improving the workability.

In addition, there is another advantage in that the present invention is constructed with a guide, a slide clip and a lock pin, thereby reducing the number of required components.

There is still a further advantage in that the guide and the slide clip are made of a light plastic material such that manufacturing costs can be relatively curtailed and the weight of a vehicle can be reduced to thereby improve the rate of fuel consumption.

What is claimed is:

1. An adjusting mechanism of a manual transmission cable, the mechanism comprising:
a lever pin integrally formed with a shift lever;
a guide so connected as to integrally move with a cable for transmitting the manipulating force of said shift lever and centrally formed with a guide hole through which said lever pin passes to move in the longitudinal direction of said cable wherein said guide hole is formed in the longitudinal direction of said cable with a plurality of teeth and both sides thereof are formed with respective guide channels;
a slide clip wherein a boss through which said lever pin passes is formed at a surface opposite to said guide hole, locking protrusions are formed at a circumference of said boss for insertion into said teeth and guide parts are movably coupled to said guide channels while said locking protrusions and said teeth are distanced from each other at a surface opposite to said guide channels and are hitched at an end of said guide by resilience when said locking protrusions are inserted into said teeth; and
fixing means coupled to the end of said lever pin which passes through said boss of said slide clip to restrict said slide clip and said lever pin so that said slide clip and said lever pin should not be broken away from each other.

2. The mechanism as defined in claim 1, wherein said guide is protrusively formed toward said cable with a boss formed with an insertion groove in the longitudinal direction of said cable to allow said cable to be pushed into the longitudinal direction thereof.

3. The mechanism as defined in claim 1, wherein said teeth of said guide are protrusively formed in a serrated shape toward said boss, and each of said locking protrusions are serrated as said teeth of said guide have corresponding serrated shapes thereof.

4. The mechanism as defined in claim 1, wherein said guide is made of a plastic material.

5. The mechanism as defined in claim 1, wherein said boss of said slide clip is shaped in a rectangle such that a surface opposite to said teeth of said guide is formed with a plurality of locking protrusions in the longitudinal direction of said cable.

6. The mechanism as defined in claim 1, wherein said guide part at said slide clip tapers off at an external end thereof.

7. The mechanism as defined in claim 1, wherein said slide clip is made of a plastic material.

8. The mechanism as defined in claim 1, wherein said fixing means is a lock pin wherein one of two bent legs thereof radially goes through the pin hole while the other leg thereof resiliently embraces said end of said lever pin and bends toward the remaining leg to hang on an upper side of said slide clip.

9. An adjusting mechanism for a manual transmission cable, comprising:
a guide member adapted to be secured to an end of the transmission cable and extend in a generally longitudinal direction with respect to the cable, said guide member defining a central opening and guide channels along top and bottom surfaces lying parallel to the longitudinal direction of the cable;
a slide clip adapted to be pivotally secured to a shift lever adjacent a bottom end of the lever, said slide clip comprising a central boss configured and dimensioned to be received in the central opening of said guide member and wing portions configured and dimensioned to extend around the top and bottom surfaces of said guide member;
guide protrusions disposed on an inner surface of each said wing portion, the guide protrusions being positioned to engage behind an edge of the guide member in a locked position and received in said guide channels in an adjustable position; and
locking elements disposed between said guide member and said slide clip boss such that the slide clip is fixed with respect to the guide member in the locked position and slideable with respect to the guide member in the adjustable position.

10. The adjusting mechanism according to claim 9, wherein said locking elements comprise gear tooth-like surfaces formed on inner longitudinal surfaces of the guide member central opening and mating gear tooth-like surface formed on mating surfaces of said slide clip boss.

11. The adjusting mechanism according to claim 9, wherein said slide clip boss defines a central hole adapted to receive a pin mounted on the shift lever.
